(19) United States
(12) Patent Application Publication
(10) Pub. No.: US 2025/0161767 A1
(43) Pub. Date: May 22, 2025

(54) GOLF CLUB HEAD

(71) Applicant: Attometal Tech Korea Inc., Gimpo-si (KR)

(72) Inventors: Jae Kyu PARK, Seoul (KR); Geun Sang CHO, Seongnam-si (KR)

(73) Assignee: Attometal Tech Korea Inc., Gimpo-si (KR)

(21) Appl. No.: 18/952,522

(22) Filed: Nov. 19, 2024

(30) Foreign Application Priority Data
Nov. 20, 2023 (KR) 10-2023-0160871
Nov. 7, 2024 (KR) 10-2024-0157008

(51) Int. Cl. A63B 53/04; B33Y 80/00

(52) U.S. Cl. CPC A63B 53/0466; A63B 53/0408; B33Y 80/00; A63B 2209/00

(57) ABSTRACT

The present disclosure relates to a golf club head that can increase strength and repulsion force, and includes a face portion formed in the front of the golf club head and directly contacting a golf ball to strike the golf ball, a crown portion extended rearward from the face portion to form an upper portion and a rear portion of the golf club head, a sole portion extended forward from the crown portion to form a bottom portion, a neck portion formed in an upper portion of the face portion and coupled with a shaft having a grip gripped by a user in the upper portion, and a reinforcing portion formed on a rear surface of the face portion, in which the reinforcing portion is formed to have an area narrower than that of the face portion on the rear surface of the face portion.

### CROSS-REFERENCE TO RELATED APPLICATIONS

This application claims priority from and the benefit of Korean Patent Application Nos. 10-2023-0160871 filed on Nov. 20, 2023 and 10-2024-0157008 filed on Nov. 7, 2024, which is hereby incorporated by reference as if fully set forth herein.

### BACKGROUND

### 1. Field

The present disclosure relates to a golf club head, and more specifically, to a golf club head that can increase strength and repulsion

### 2. Description of Related Art

All golf clubs are manufactured in various forms within the scope set forth in Article 4 of Chapter 3 of the Rules of Golf and the Supplementary Provisions, and are made to enable golfers to swing more easily while achieving the intended direction and distance.

In order to improve the directionality of golf clubs, club heads are being manufactured by developing technologies such as lowering and dispersing the center of gravity, and in order to increase the distance of golf balls, in addition to adjusting the weight and elasticity of a club shaft, technologies are being developed to increase a repulsive force of a face of the golf club head to a coefficient of restitution of 0.83 stipulated by the golf rules.

Additionally, various technologies are being developed and applied to increase the area of the sweet spot, which is the optimal rebound point, as much as possible.

A material used for the golf club head is usually 6-4 titanium or beta titanium.

A manufacturing method of the golf club head include 2 pcs casting method, 4 pcs forging method, and 1 pcs 3DP method, and depending on the manufacturing method, a welding process may be added.

Moreover, an internal structure of a golf driver is a hollow structure, and in order to create a distance effect using elasticity when hitting a golf ball, the thickness of each part of the driver is designed differently for each part.

For example, a face part is usually manufactured to a thickness of about 2.5 to 4.5 mm, and as the thickness increases, an energy loss phenomenon occurs, the coefficient of restitution tends to decrease, and there is a disadvantage of the center of gravity being located forward.

Meanwhile, when the thickness of the face part becomes thinner than 2.5 mm, the coefficient of restitution increases, but the frequency of occurrence of a shape that cannot withstand the impact of hitting a golf ball and breaks increases.

Recently, various attempts have been made in driver design, such as structures to increase the elasticity of the entire driver, especially structures to fix the head as a whole and increase the elasticity of the face part that directly contacts the golf ball, and structures to reduce damage to the face part when hitting a golf ball.

However, when manufacturing by casting and forging, there is a problem that it is difficult to provide various changes in the internal structure due to limitations in mold technology.

According, there are bound to be limitations in the structural design that can increase the rigidity and elasticity of the face part that directly contacts the golf ball.

For the above reasons, the field is seeking ways to increase the strength and repulsive force of golf club heads, but so far, satisfactory results have not been achieved.

### SUMMARY

In order to solve the problems described above, the present disclosure provides a golf club head capable of increasing the strength and repulsive force of the golf club head.

The above-mentioned and other purposes, advantages and features of the present disclosure, and the methods for achieving them will become apparent with reference to the embodiments described below in detail together with the attached drawings.

In order to achieve the objects, according to an embodiment of the present disclosure, there is provided a golf club head including: a face portion formed in the front of the golf club head and directly contacting a golf ball to strike the golf ball; a crown portion extended rearward from the face portion to form an upper portion and a rear portion of the golf club head; a sole portion extended forward from the crown portion to form a bottom portion; a neck portion formed in an upper portion of the face portion and coupled with a shaft having a grip gripped by a user in the upper portion; and a reinforcing portion formed on a rear surface of the face portion, in which the reinforcing portion is formed to have an area narrower than that of the face portion on the rear surface of the face portion.

The reinforcing portion may be formed in a lattice structure.

A thickness of the face portion may be 1 to 3.5 mm, and a thickness of the reinforcing portion may be about 1 to 3.5 mm.

The reinforcing portion may be integral with the face portion.

The reinforcing portion may be coupled with the face portion in an insertion manner.

According to another embodiment of the present disclosure, there is provided a golf club head including: a face portion formed in the front of the golf club head and directly contacting a golf ball to strike the golf ball; a crown portion extended rearward from the face portion to form an upper portion and a rear portion of the golf club head; a sole portion extended forward from the crown portion to form a bottom portion; a neck portion formed in an upper portion of the face portion and coupled with a shaft having a grip gripped by a user in the upper portion; and a reinforcing portion formed on a rear surface of the face portion and a boundary surface between a rear surface of the sole portion and the rear surface of the face portion.

The reinforcing portion may be formed on the rear surface of the face portion and an edge region of the boundary surface between the rear surface of the sole portion and the rear surface of the face portion.

The reinforcing portion may be formed on the rear surface of the face portion and a periphery of the boundary surface between the rear surface of the sole portion and the rear surface of the face portion.

The face portion, the crown portion, the sole portion, the neck portion, and the reinforcing portion may be manufactured by a 3D printing method.

A golf club head may be made of either titanium or carbon or a combination thereof.

According to the present disclosure, the lattice structure of the reinforcing portion is a grid-shaped structure including repetitive elements in a certain pattern, and has the effect of reducing weight and increasing strength.

Therefore, the reinforcing portion formed of a lattice structure can distribute force according to the lattice structure shape, and thus has the effect of effectively withstanding the same strength and pressure with less weight.

In the lattice structure of the reinforcing portion, the reinforcing portion composed of any one of square, pentagon, hexagon, icosahedral, Kagome, rhombus, tetrahedron, or Voronoi unit cells or a combination thereof is manufactured using a 3D printing method. Therefore, free internal structural design and structural installation that would otherwise be impossible with a mold-type manufacturing method are possible, and additional elasticity resulting from this can be used to achieve a distance-enhancing effect.

### BRIEF DESCRIPTION OF DRAWINGS

FIG. 1 is a perspective view illustrating a golf club according to one embodiment of the present disclosure.

FIG. 2 is a front view illustrating a golf club head according to one embodiment of the present disclosure.

FIG. 3 is an example diagram illustrating a lattice structure according to one embodiment of the present disclosure.

FIG. 4 is a cross-sectional view illustrating a cross-section of a face portion and a reinforcing portion according to one embodiment of the present disclosure.

FIG. 5 is a front view of a golf club head illustrating a modification example of the present disclosure.

FIG. 6 is a front view of a golf club head illustrating another modification example of the present disclosure.

### DETAILED DESCRIPTION

The Embodiments of the present disclosure are provided to more fully explain the present disclosure to those skilled in the art, and the embodiments may be modified in many different forms, and the scope of the present disclosure is not limited to the embodiments. Rather, these embodiments are provided to more faithfully and completely convey the spirit of the present disclosure to those skilled in the art. In addition, in the drawings below, each component is exaggerated for convenience and clarity of description, and like reference numerals represent like elements in the drawings. As used herein, the term “and/or” includes any one of the listed items and any combination of one or more.

The terminology used herein is for the purpose of describing particular embodiments only and is not intended to limit the present disclosure.

As used herein, the singular forms include the plural forms unless the context clearly dictates otherwise. Moreover, when used herein, the words “comprise” and/or “comprising” specify the presence of stated features, numbers, steps, operations, elements, elements and/or groups thereof, but do not preclude the presence or addition of one or more other features, numbers, operations, elements, elements and/or groups thereof.

Hereinafter, preferred embodiments of the present disclosure are described in detail with reference to the attached drawings.

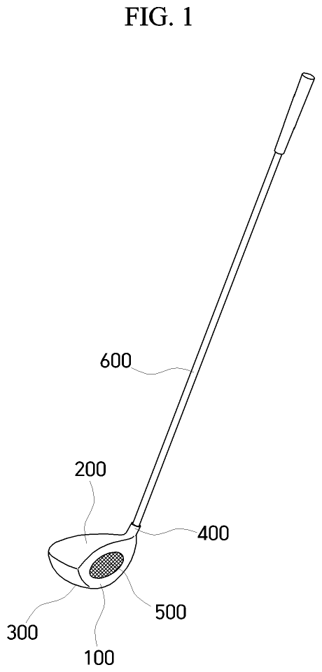

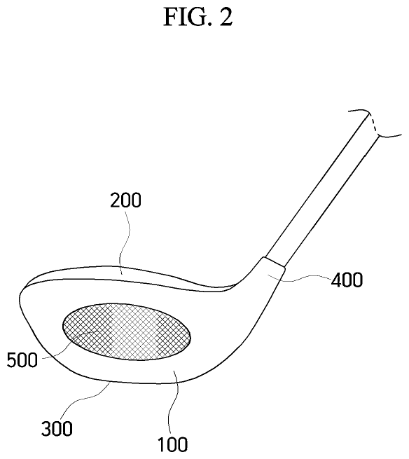

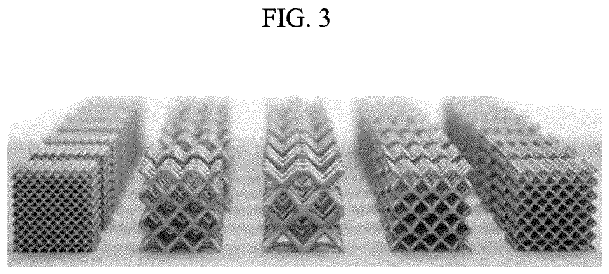

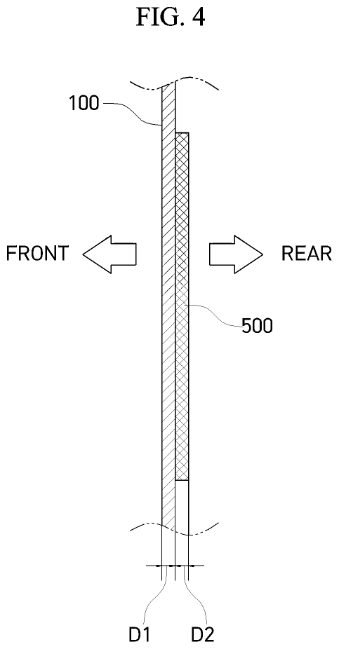

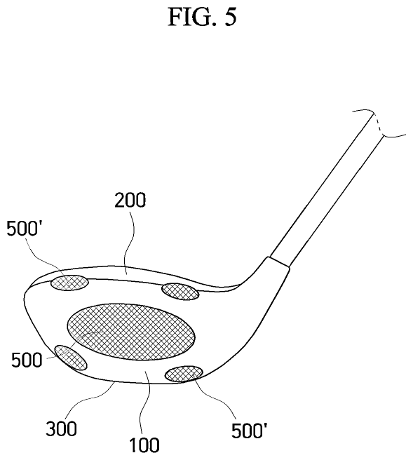

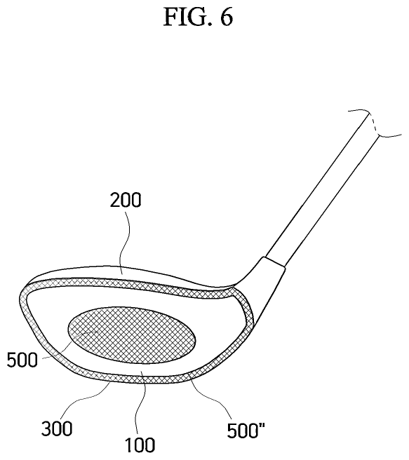

FIG. 1 is a perspective view illustrating a golf club according to one embodiment of the present disclosure, FIG. 2 is a front view illustrating a golf club head according to one embodiment of the present disclosure, FIG. 3 is an example diagram illustrating a lattice structure according to one embodiment of the present disclosure, FIG. 4 is a cross-sectional view illustrating a cross-section of a face portion and a reinforcing portion according to one embodiment of the present disclosure, FIG. 5 is a front view of a golf club head illustrating a modification example of the present disclosure, and FIG. 6 is a front view of a golf club head illustrating another modification example of the present disclosure.

Referring to FIGS. 1 to 6, a golf club head according to one embodiment of the present disclosure includes a face portion 100, a crown portion 200, a sole portion 300, a neck portion 400, and a reinforcing portion 500.

The golf club head of this present disclosure is manufactured using a 3D printing method.

That is, the present disclosure is manufactured using a 3D printing method, and accordingly, free internal structural design and structural installation that would otherwise be impossible with a mold-type manufacturing method are possible, and additional elasticity resulting from this can be used to achieve a distance-enhancing effect.

Additionally, the golf club head according to one embodiment of the present disclosure may be made of either titanium or carbon or a combination thereof.

For convenience of explanation, unless otherwise specified, the face portion 100 that strikes a golf ball is called the front, and the back of the face portion 100 is called the rear.

Additionally, the internal structure of the golf club head in the present disclosure may be a hollow structure or the hollow portion may be filled with a lightweight urethane filler.

This is an inevitable structure to control the weight of the golf club head. The golf club head must maintain the volume (4600 cc or less) stipulated in the golf rules, and the repulsive force of the face portion is made with rigidity and thickness that can obtain the maximum repulsive force within the range (coefficient of restitution of 0.83 or less) regulated by the golf rules.

The face portion 100 is formed in the front and comes into contact with the golf ball, and is the surface that strikes the golf ball.

The crown portion 200 is an upper cover that extends rearward from the face portion 100 to form an upper portion and a rear portion, and supports the face portion 100 while adding a certain amount of weight.

The sole portion extends forward from the crown portion 200 to form the bottom portion, and is positioned closest to the ground when the golf ball makes contact with the face portion 100.

In addition, the sole portion 300 is a portion that connects the face portion 100 and the crown portion 200 and can absorb some of the shock transmitted from the golf ball when hitting the golf ball.

The neck portion is formed in an area where the shaft 600 is coupled with the upper side of the face portion 100, is coupled with the shaft 600 having a grip that can be gripped by a user in the upper portion thereof, and extends upward from the face portion 100.

The face portion 100, crown portion 200, sole portion 300, and neck portion 400 are designed with different thicknesses of titanium or titanium alloy for each part, and a carbon molded material may be used partially instead of titanium material.

Meanwhile, in one embodiment of the present disclosure, the face portion 100, the crown portion 200, the sole portion 300, and the neck portion 400 were described as being made of titanium or carbon molding, but stainless steel, soft iron, or the like may be included and used to enhance the rigidity of the face portion 100, the crown portion 200, the sole portion 300, and the neck portion 400.

The reinforcing portion 500 is formed in an area of the face portion 100 that the golf ball directly comes into contact with. Specifically, the reinforcing portion is formed on the rear surface of the face portion 100 in the golf club head having a hollow structure with an empty internal structure, and is located at a location that determines the elasticity and distance of the driver.

That is, the reinforcing portion 500 has an area narrower than that of the face portion 100.

Therefore, the reinforcing portion 500 is located at the rear surface of the so-called sweet spot of the face portion 100.

As described above, this reinforcing portion 500 is manufactured together with the face portion 100, the crown portion 200, the sole portion 300, and the neck portion 400 using a 3D printing method.

That is, the golf club head of the present disclosure may be formed as a single piece.

Therefore, the golf club head of the present disclosure is manufactured as a single piece using the 3D printing method, and thus, free internal structural design and structural installation that would otherwise be impossible with a mold-type manufacturing method are possible, and additional elasticity resulting from this can be used to achieve a distance-enhancing effect.

Meanwhile, the golf club head of the present disclosure can be manufactured as a single piece using a 3D printing method. However, the reinforcing portion 500 and the face portion 100 are manufactured by a 3D printing method, the crown portion 200 is manufactured by a 3D printing method, and the sole portion 300 and the neck portion 400 are manufactured using a 3D printing method, and the reinforcing portion 500 may be coupled to the face portion 100 using an insert method.

In addition, by detachably coupling the reinforcing portion 500 to the face portion 100, when the time comes to replace the golf club head or the reinforcing portion 500 is damaged due to repeated hitting with a golf ball, only the reinforcing portion 500 may be replaced without replacing the entire golf club head, thereby reducing the maintenance cost of the golf club head.

Additionally, the reinforcing portion 500 can be formed with grooves or protrusions having various shapes.

The groove may be formed across the reinforcing portion 500 and may have a shape parallel to the sole portion 300.

In particular, the reinforcing portion 500 is formed of a lattice structure.

The lattice structure is a grid-shaped structure as illustrated in FIG. 3, and is composed of repetitive elements in a certain pattern, and can reduce weight and increase strength.

Accordingly, the reinforcing portion 500 formed of a lattice structure can distribute force according to the lattice structure shape, and can effectively withstand the same strength and pressure with a smaller weight.

FIG. 4 is a cross-sectional view illustrating a cross-section of the face portion and the reinforcing portion according to one embodiment of the present disclosure.

Referring to FIG. 4, a thickness D1 of the face portion 100 according to one embodiment of the present disclosure is 1 to 3.5 mm, and a thickness D2 of the reinforcing portion 500 is approximately 1 to 3.5 mm.

Accordingly, by manufacturing the face portion 100 thinly, a high coefficient of restitution and energy loss can be minimized, and a high level of strength can be maintained and breakage can be prevented by the reinforcing portion 500 of the rear surface.

In addition, since the reinforcing portion 500 is made of a relatively light lattice structure and material, the center of gravity of the entire head can be advantageously adjusted.

The lattice structure of the reinforcing portion 500 may be formed of any one of square, pentagonal or hexagonal structure unit cells or a combination thereof.

Additionally, the lattice structure of the reinforcing portion 500 may be formed of any one of icosahedral, Kagome, rhombus, tetrahedron, or Voronoi unit cells or a combination thereof.

The reinforcing portion 500 composed of icosahedral unit cells is mainly used for products requiring high strength and durability, and all faces have the same size, and due to high symmetry, it achieves uniform strength and stability in various directions.

The reinforcing portion 500 made of Kagome unit cells is mainly used for manufacturing thin plates or lightweight structures with high strength, and the triangles overlap each other to form a very strong lattice shape, and can evenly distribute compressive and tensile loads.

The reinforcing portion 500 composed of rhombus unit cells is composed of parallelogram faces, is strong against asymmetric load distribution, and provides high strength and durability in a specific direction.

The reinforcing portion 500 composed of tetrahedral unit cells is composed of four triangular faces, has high strength-to-weight ratio, is resistant to deformation, and can respond to loads in various directions by evenly distributing the load.

In addition, the reinforcing portion 500 composed of tetrahedral unit cells has a simple design and can be formed into various shapes by coupling with other structures.

The reinforcing portion 500 made of Voronoi unit cells is formed in a random and irregular shape inspired by nature, and is efficient in shock absorption and energy dissipation by distributing the load in multiple directions.

The reinforcing portion 500 including the unit cells is manufactured using a 3D printing method, and accordingly, free internal structural design and structural installation that would otherwise be impossible with a mold-type manufacturing method are possible, and additional elasticity resulting from this can be used to achieve a distance-enhancing effect.

The golf club head according to one embodiment of the present disclosure may be made of either titanium or carbon or a combination thereof.

FIG. 5 is a front view of a golf club head illustrating a modification example of the present disclosure.

The reinforcing portion 500 according to one embodiment of the present disclosure is described as being formed on the rear surface of the region of the face portion 100 directly contacting the golf ball. However, a reinforcing portion 500′ according to the modification example of the present disclosure may be formed on the rear surface of the face portion 100 and an edge region of a boundary surface between the rear surface of the sole portion 300 and the rear surface of the face portion 100, as illustrated in FIG. 5.

That is, the reinforcing portion 500′ can be formed in a point shape at the edge region of the edge of the face portion 100.

FIG. 6 is a front view of a golf club head illustrating another modification example of the present disclosure.

According to another modification example of the present disclosure, a reinforcing portion 500″ may be formed on the rear surface of the face portion 100 and along a periphery of the boundary surface between the rear surface of the sole portion 300 and the rear surface of the face portion 100, as illustrated in FIG. 6.

That is, the reinforcing portion 500″ can be formed in a band shape along the periphery of the edge area of the face portion 100.

Therefore, the positions of the reinforcing portions 500′ and 500″ according to the modification examples of the present disclosure can effectively prevent the peripheral portion of the face portion 100 from being crushed or damaged when the reinforcing portion 500 hits the golf ball by increasing the strength of the peripheral portion of the face portion 100.

In the modification examples where the reinforcing portions 500′ and 500″ are formed on the periphery of the face portion 100 as described above, it is natural that the reinforcing portion 500 is formed so that the golf ball directly contacts the rear surface of the face portion 100.

Meanwhile, although the face portion 100 and the reinforcing portions 500, 500′, and 500″ according to one embodiment of the present disclosure are described as being coupled to each other in an insert manner, according to another embodiment of the present disclosure, the golf club head including the face portion 100, the crown portion 200, the sole portion 300, the neck portion 400, and the reinforcing portion 500, 500′, and 500″ can be manufactured by a 3D printing method.

Accordingly, the golf club head according to another embodiment of the present disclosure is manufactured using a 3D printing method. Therefore, free internal structural design and structural installation that would otherwise be impossible with a mold-type manufacturing method are possible, and additional elasticity resulting from this can be used to achieve a distance-enhancing effect.

As such, the embodiments disclosed herein should be considered in an illustrative rather than a restrictive sense. The scope of the present disclosure is indicated by the claims rather than the foregoing description, and all differences which come within the scope equivalent thereto should be construed as being included in the present disclosure.

What is claimed is:

1. A golf club head comprising:
a face portion formed in the front of the golf club head and directly contacting a golf ball to strike the golf ball;
a crown portion extended rearward from the face portion to form an upper portion and a rear portion of the golf club head;
a sole portion extended forward from the crown portion to form a bottom portion;
a neck portion formed in an upper portion of the face portion and coupled with a shaft having a grip gripped by a user in the upper portion; and
a reinforcing portion formed on a rear surface of the face portion,
wherein the reinforcing portion is formed to have an area narrower than that of the face portion on the rear surface of the face portion.

2. The golf club head of claim 1, wherein the reinforcing portion is formed in a lattice structure.

3. The golf club head of claim 1, wherein a thickness of the face portion is 1 to 3.5 mm, and a thickness of the reinforcing portion is about 1 to 3.5 mm.

4. The golf club head of claim 1, wherein the reinforcing portion is integral with the face portion.

5. The golf club head of claim 1, wherein the reinforcing portion is coupled with the face portion in an insertion manner.

6. A golf club head comprising:
a face portion formed in the front of the golf club head and directly contacting a golf ball to strike the golf ball;
a crown portion extended rearward from the face portion to form an upper portion and a rear portion of the golf club head;
a sole portion extended forward from the crown portion to form a bottom portion;
a neck portion formed in an upper portion of the face portion and coupled with a shaft having a grip gripped by a user in the upper portion; and
a reinforcing portion formed on a rear surface of the face portion and a boundary surface between a rear surface of the sole portion and the rear surface of the face portion.

7. The golf club head of claim 6, wherein the reinforcing portion is formed on the rear surface of the face portion and an edge region of the boundary surface between the rear surface of the sole portion and the rear surface of the face portion.

8. The golf club head of claim 6, wherein the reinforcing portion is formed on the rear surface of the face portion and a periphery of the boundary surface between the rear surface of the sole portion and the rear surface of the face portion.

9. The golf club head of claim 1, wherein the face portion, the crown portion, the sole portion, the neck portion, and the reinforcing portion are manufactured by a 3D printing method.

10. The golf club head of claim 9, wherein a golf club head is made of either titanium or carbon or a combination thereof.
